(19) United States
(12) Patent Application Publication
(10) Pub. No.: US 2016/0309905 A1
(43) Pub. Date: Oct. 27, 2016

(54) WALL SURFACE COVERING

(71) Applicant: Lauren Esplin, Queenscliff (AU)

(72) Inventor: Lauren Esplin, Queenscliff (AU)

(21) Appl. No.: 15/140,098

(22) Filed: Apr. 27, 2016

(30) Foreign Application Priority Data
Apr. 27, 2015 (AU) 2015901492

(51) Int. Cl. A47C 19/02; B29C 65/48; E04F 13/25; E04F 13/08; E04F 13/10

(52) U.S. Cl. CPC A47C 19/022; E04F 13/0862; E04F 13/0887; E04F 13/10; E04F 13/25; B29C 65/48; B29L 2031/732

(57) ABSTRACT

A wall surface covering has a plurality of modular tile members made of a lightweight material. Each tile member has a decorative surface and an opposite wall surface facing surface. The wall surface covering has a means for removably adhering the tile members to a wall surface with the wall surface facing surface of each of the tile members facing the wall surface. The plurality of tile members are adapted to be located closely adjacent to one another, such that the decorative surfaces of the tile members form a substantially continuous wall covering decorative surface.

### TECHNICAL FIELD

The present invention relates to surface coverings in particular, though not exclusively, wall surface coverings and functional wall surface coverings for use as a headboard for a bed.

### BACKGROUND OF INVENTION

Existing bed structures can include a bed frame and a mattress or a mattress resting on a box spring supported by a frame on legs or wheels. Often, a decorative headboard and/or footboard are attached to either the frame or box spring, or both, to enhance the aesthetic appearance of the bed. Headboards can be attached directly to the frame or may be a freestanding furniture piece that is positioned against a wall surface at the head of the bed.

Headboards may be comprised of an upholstered timber frame or may be comprised of an exposed timber or metal piece. Such headboards are heavy, expensive and permanent and offer little or no flexibility in terms of their appearance. Another drawback with such headboards is that although they may suit the decor of one dwelling they may not suit the decor of another dwelling if the owner moves dwellings or even the same dwelling if the owner redecorates.

Headboards that are formed as independent pieces are often bulky and heavy and in the interests of safety it is recommended that they be affixed to a wall to eliminate the risk of tipping over. Affixing a headboard to a wall requires the use of fasteners or the like to penetrate the wall surface. It is often not desirable to use wall surface penetrating fasteners particularly in rented accommodation where the use of wall penetrating fasteners might be prohibited or where remedial work to repair the wall surface would be required.

A drawback associated with existing headboards is that they are typically not useful for any other purpose. Should a headboard need replacing after redecorating the only option might be to discard the unwanted headboard. The present invention seeks to ameliorate these and other problems with existing headboards.

### SUMMARY OF INVENTION

In one aspect, the present invention provides a wall surface covering, including a plurality of modular tile members comprised of a lightweight material, each tile member comprising a decorative surface and an opposite wall surface facing surface. The invention further includes means for removably adhering the tile members to a wall surface with the wall surface facing surface of each of the tile members facing the wall surface, wherein the plurality of tile members are adapted to be located closely adjacent one another whereby the decorative surfaces of the tile members form a substantially continuous wall covering surface.

Preferably, the lightweight material has a density of between about 100 and about 900 kg/m³, or between about 100 and about 400 or 650 kg/m³. In some embodiments the lightweight material is comprised of balsa wood of a density of about 160 kg/m³ and/or is comprised of ply wood. The density of pine plywood is in the range 500-650 kg/m3. Eucalypt hardwood plywood density can exceed 900 kg/m3 depending on the timber species used.

Preferably, the means for removably adhering the tile members to the wall surface includes pressure sensitive adhesive applied to the wall facing surface of each of the tile members.

The decorative surfaces of the tile members can include decorative elements whereby the decorative surfaces of the plurality of tile members form a tessellated pattern.

The dimensions of each of the plurality of tile members are preferably the same and are of a magnitude that the overall width of n tile members is sufficient to accommodate standard single, king single, double, queen, king and super king size bed widths.

Preferably, the dimensions of each of the plurality of tile members are about 200 mm×200 mm×4 mm.

The present invention is advantageous in that it comprises a modular system of the tile members which can be adhered to a wall surface in a variety of configurations and/or orientations and/or quantities to form the overall wall surface covering. Furthermore, the overall dimensions of the wall covering can be altered based on the number of tile members adhered to the wall which is particularly advantageous where the wall surface covering is employed as a headboard for beds of various sizes. Furthermore, the lightweight material used to form the tile members is such that they can be removably adhered to the wall surface without requiring wall penetrating fasteners or the like. Furthermore, the wall surface covering is advantageous in that it provides suitable protection for a wall surface where the covering is used, for example, as a headboard. In embodiments, the means for adhering the tile members to the wall surface may provide a gap between the tile members and the wall surface that in combination with the flexibility of the tile members allows for some degree of resilience to impact without damaging the wall surface.

In another aspect, the invention includes a headboard for a bed, including: a plurality of modular tile members comprised of a lightweight material; each tile member comprising a decorative surface and an opposite wall surface facing surface; means for removably adhering the tile members to a wall surface with the wall surface facing surface of each of the tile members facing the wall surface; wherein the plurality of tile members are adapted to be located closely adjacent one another to form a headboard for a bed wherein the decorative surfaces of the tile members form a substantially continuous wall covering surface.

Preferably, the lightweight material has a density of between about 100 and about 400 kg/cm³, or between about 100 and about 200 kg/m³ or range 500-650 kg/m3 and/or is comprised of ply wood.

Preferably, the means for removably adhering the tile members to the wall surface includes pressure sensitive adhesive applied to the wall facing surface of each of the tile members.

Preferably, the dimensions of each of the plurality of tile members are the same and are of a magnitude that the overall width of n tile members is sufficient to accommodate standard single, king single, double, queen, king and super king size bed widths.

In another aspect, the present invention provides a kit for forming a headboard. The kit includes a plurality of tile members comprised of a lightweight material. Each tile member comprises a decorative surface and an opposite wall surface facing surface and means are provided for removably adhering the tile members to a wall surface with the wall surface facing surface of each of the tile members facing the wall surface wherein the plurality of tile members are adapted to be located closely adjacent one another whereby the tile members form a headboard comprising a substantially continuous wall covering surface, which is preferably a decorative surface. The kit preferably includes a package for containing a predetermined number of the tile members required to form a headboard suited for any one or more of standard single, king single, double, queen, king or super king size bed widths. The kit can further include a package for containing a predetermined number of the tile members required to form a headboard suited for any one or more of standard single, king single, double, queen, king or super king size bed widths. The means for removably adhering the tile members to the wall surface includes pressure sensitive adhesive applied to the wall facing surface of each of the tile members.

In another aspect, the invention provides a method for forming a headboard, the method including: providing a plurality of tile members comprised of a lightweight material, each tile member comprising a decorative surface and an opposite wall surface facing surface; adhering the tile members to a wall surface with the wall surface facing surface of each of the tile members facing the wall surface wherein the plurality of tile members are located closely adjacent one another whereby the tile members form a headboard comprising a substantially continuous wall covering decorative surface. The method can further include providing a package for containing a predetermined number of the tile members required to form a headboard suited for any one or more of standard single, king single, double, queen, king or super king size bed widths. The method can include providing means for removably adhering the tile members to the wall surface in the form of pressure sensitive adhesive applied to the wall facing surface of each of the tile members.

### BRIEF DESCRIPTION OF DRAWINGS

The present invention will now be described in more detail with reference to preferred embodiments of the invention illustrated in the figures, wherein:

FIG. 1 illustrates a wall surface covering comprised of a plurality of modular tile members removably adhered to a wall surface to form a headboard for a bed in accordance with a preferred embodiment of the invention;

FIG. 2 illustrates the wall surface covering of FIG. 1, wherein a reduced number of the plurality of tile members of FIG. 1 are removably adhered to a wall surface for purely aesthetic purposes to provide a wall feature;

FIG. 3 illustrates a perspective view illustrating, in particular, a decorative surface of one of the plurality of tile members of the decorative wall surface covering of FIG. 1;

FIG. 4 illustrates a perspective view, illustrating in particular the opposite wall surface facing surface of the tile member of FIG. 3, wherein the wall facing surface includes means for removably adhering the tile member to a wall surface in the form of a plurality of pressure sensitive adhesive members;

FIG. 5 illustrates a side view of the tile member of FIGS. 3 and 4 wherein the tile member is removably adhered to a wall surface with the wall surface facing surface of the tile member facing the wall surface and the decorative surface facing away from the wall surface.

### DETAILED DESCRIPTION

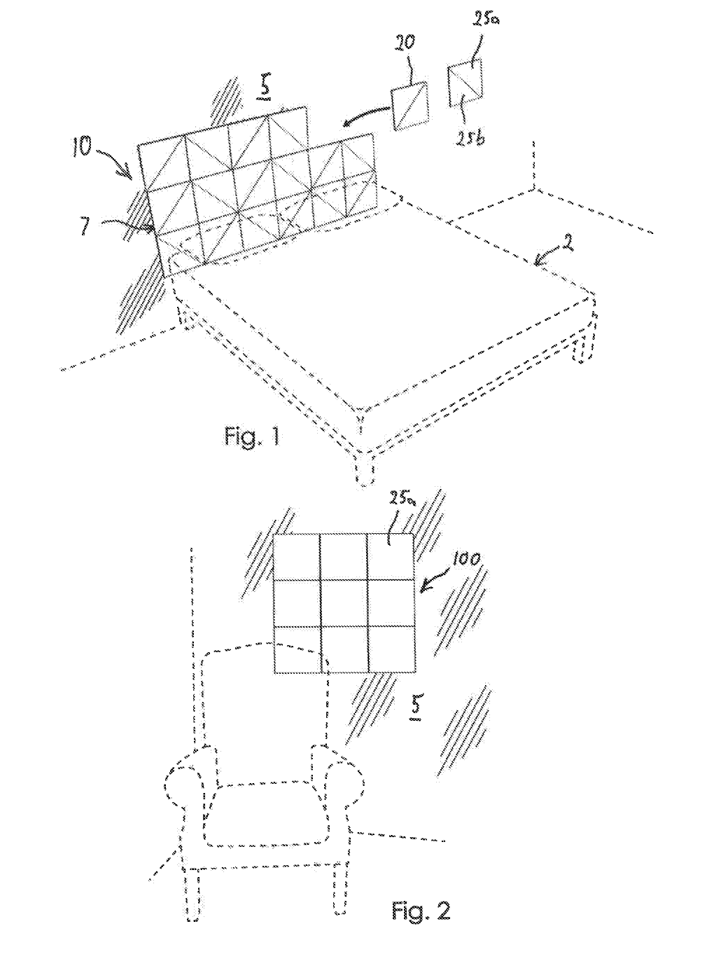

In a preferred embodiment of the invention illustrated in FIG. 1, there is provided a wall surface covering 10 including a plurality of modular tile members 20 each formed out of a lightweight material. Each tile member 20 comprises a decorative surface 25 and an opposite wall surface facing surface 27. As illustrated in FIG. 1, the wall surface covering 10 is adapted to be removably applied to a wall surface 5 in a manner that will be described herein. The wall surface covering 10 includes means for removably adhering the tile members 20 to the wall surface 5 with the wall surface facing surface 27 of each of the tile members 20 facing the wall surface 5. The plurality of tile members 20 are adapted to be located closely adjacent or abutting one another whereby the decorative surfaces 25 of the tile members 20 form a substantially continuous decorative wall covering surface 30. In the embodiment illustrated in FIG. 1, the wall surface covering 10 is adapted to form a headboard 7 removably adhered to the wall surface 5 with a bed 2 located adjacent thereto. As the tile members 20 are modular they can be adhered to the wall surface 5 in a variety of configurations and/or orientations and/or quantities to form the overall decorative wall surface covering 10.

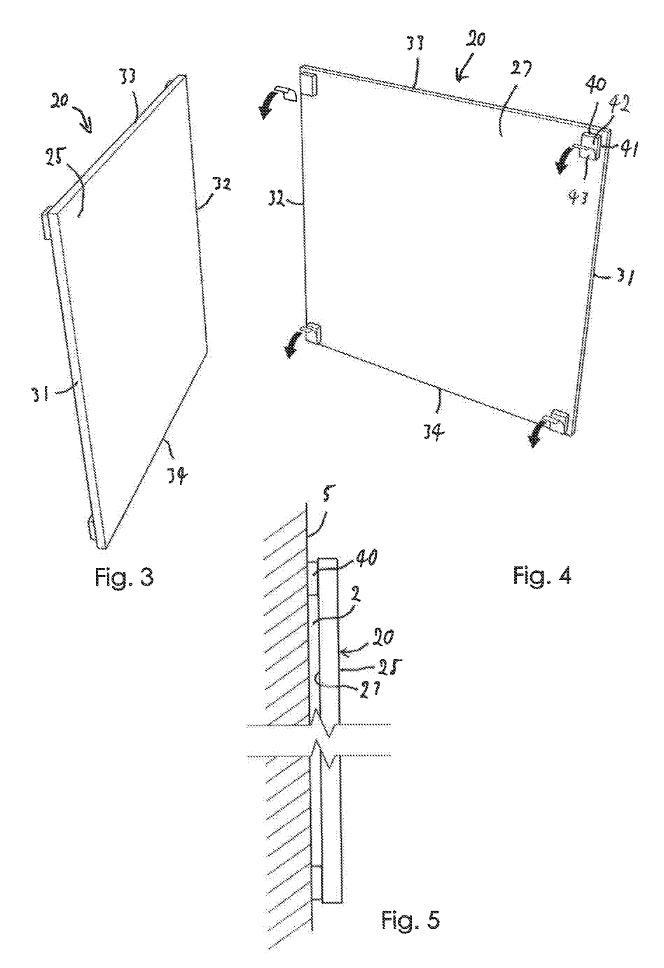

Referring to FIGS. 3, 4 and 5, there is shown an individual one of the tile members 20. FIG. 3 illustrates, in particular, the decorative surface 25 of the tile member 20 which terminates at a pair of laterally opposite side edges 31, 32 and opposite top and bottom edges 33, 34. The tile member 20 illustrated in FIGS. 1 to 5 is square in shape and preferably has a width of about 200 mm and a height of about 200 mm and a thickness of about 4 mm. FIG. 4 illustrates, in particular, the opposite wall surface facing surface 27 of the tile member 20 which also terminates at the laterally opposite side edges 31, 32 and at the opposite top and bottom edges 33, 34.

It is to be appreciated that in other embodiments, the tile members 20 may be other polygonal shapes such as a parallelogram or a rhombus or may be triangular, pentagonal, hexagonal, heptagonal, octagonal.

The wall surface facing surface 27 of the tile member 20 includes a plurality of pressure sensitive adhesive members 40 that are adapted for removably adhering the tile member 20 to the wall surface 5 with the wall surface facing surface 27 facing the wall surface 5. Each of the pressure sensitive adhesive members 40 is comprised of a double sided pressure sensitive adhesive member. One pressure sensitive adhesive surface 41 of the pressure sensitive adhesive member 40 is adhered to the wall surface facing surface 27 of the tile member 20 and an opposite pressure sensitive adhesive surface 42 faces away from the wall surface facing surface 27 of the tile member 20. The opposite pressure sensitive adhesive surface 42 is initially covered by a covering member 43 which is removable to expose the pressure sensitive adhesive surface 42 prior to being placed into contact with the wall surface 5. The pressure sensitive adhesive member 40 has a thickness defined between the opposite surfaces 41, 42 and is comprised of a resilient foam material. The thickness of the pressure sensitive member can be up to 1 mm, between about 1 mm and 2 mm, between about 2 mm and 3 mm, between about 3 mm and 4 mm or between about 4 mm and 5 mm. In other embodiments, other means for removably adhering the tile members 20 to the wall surface 5 can be employed that are capable of retaining the tile member 20 to the wall surface 5 without requiring penetration or significant damage the wall surface 5. The use of pressure sensitive adhesive tape members 40 is advantageous as the tile member 20 can be removed from the wall surface 5 without substantially damaging the wall surface 5. The wall surface covering 10 may also include strip members or other spacing members (not shown) that are adapted to be located between adjacent edges of adjacent tile members 20.

As mentioned above, the tile members 20 are comprised of lightweight material. As a result, the pressure sensitive adhesive members 40 provide sufficient adherence to the wall surface 5 to support the weight of the tile members 20. The lightweight material preferably has a density of between about 100 and about 900 kg/m³, or between about 100 and about 400 or 650 kg/m³. In some embodiments the lightweight material is comprised of balsa wood of a density of about 160 kg/m³ and/or is comprised of ply wood. The density of pine plywood is in the range 500-650 kg/m3. Eucalypt hardwood plywood density can exceed 900 kg/m3 depending on the timber species used. However, it is to be appreciated that other lightweight materials could be employed such as a polymeric material, linoleum, rubber, cork, polyurethane, polyvinyl chloride polymeric foam such as polyurethane foam, polyvinyl chloride foam, Styrofoam, cardboard, paper or other material formed from cellulose, metal, vinyl, metallic sheeting, bamboo and may include a combination of materials also including a fabric upholstery, painted, printed, etched, dyed, stamped, image transfered, heat applied membranes or a mirror finish.

As illustrated in FIG. 5, each one of the tiles 20 is adapted to be removably adhered to the wall surface 5 by the plurality of pressure sensitive adhesive members 40 located between the wall surface 5 and the wall surface facing surface 27 of the tile member 20. The tile member 20 and the wall surface covering 10 formed therefrom is capable of exhibiting a degree of flexibility and resilience. The flexibility and resilience of the tile member 20 and the wall surface covering 10 is due to the flexibility of the lightweight material forming the tile member 20 and also due to the provision of a gap 2 between the tile member 20 and the wall surface 5 that is substantially equivalent to the thickness of the pressure sensitive adhesive members 40. The flexibility and resilience of the tile member 20 and the wall surface covering 10 can also, at least in part, be due to the compressibility of the pressure sensitive adhesive members 40, which, as mentioned above, can be formed out of a compressible foam material. Some level of flexibility and resilience is particularly advantageous where the wall surface covering 10 is used to form a headboard as illustrated in FIG. 1.

FIG. 2 illustrates another embodiment of the decorative wall surface covering 100 wherein a plurality of the tile members 20 of FIG. 1 are removably adhered to a wall surface 5 for purely aesthetic purposes to provide a wall feature. Thus, as can be seen in FIG. 2, the tile members 20 of the present invention may be used to form a wall surface covering that is used for purely aesthetic purposes and not necessarily for a functional purpose such as for use as a headboard.

As illustrated in FIG. 1, the decorative surface 25 of each of the tile members 20 includes at least one, or as in the embodiment illustrated in FIG. 1, two decorative elements 25a, 25b. The decorative elements 25a, 25b are comprised of a pair of symmetrical triangular shaped decorative elements. It is to be appreciated that the decorative surface 25 of the tile members 20 may include decorative elements of other shapes and configurations. Thus, when the plurality of tile members 20 are applied to the wall surface 5 as illustrated in FIG. 1 with the tile members 20 be located closely adjacent or in abutment with each other along edges 31, 32, 33, 34 thereof the resulting wall surface covering 10 exhibits a tessellated pattern. The decorative elements 25a, 25b may be applied in the form of a pigment such as paint, dye or the like or may be applied in the form of fabric to the decorative surface 25 of the tile members 20. Alternatively, as illustrated in FIG. 2, each of the tile members 20 may include a single decorative element 25a in the form of a uniform block colour whereby the decorative element 25a comprises the entire decorative surface 25 of the each one of the tile members 20. Thus, the plurality of tile members 20 may include decorative surfaces 25 comprised of decorative elements 25a or different colours such that when applied to the wall surface 5 results in a wall surface covering 10 comprised of a tessellated pattern of squares.

In another embodiment, each of the tile members 20 may include a single decorative element 25a, which may be printed or otherwise applied to the tile members 20. The decorative element 25a may be an individual image such as a photographic image or a reproduction of an artistic work such that when the tile members 20 are assembled together and applied to the wall surface 5 the decorative elements 25a appear as a collage of individual images. Alternatively, the decorative element 25a may comprise a part of a larger image or artistic work. As such, when the tile members 20 are assembled together and applied to the wall surface 5 in a predetermined configuration the decorative elements 25a applied to the decorative surfaces 25 of the plurality of tile members 20 form a decorative wall surface covering 10 comprising a single image such as a photographic image or a reproduction of part or all of an artistic work.

As illustrated in FIG. 1 the dimensions of each of the plurality of tile members 20 is the same and are of a magnitude such that the overall width of n tile members is sufficient to accommodate standard bed widths such as a single bed width, a king single bed width, a double bed width, a queen size bed width, a king size bed width and a super king size bed width. In a preferred form, the dimensions of the tile members 20 are 20 cm×20 cm as it has been found that such a dimension is such that n tile members are able to accommodate standard single size bed width of about 915 mm, king single size bed width of about 1070 mm, double size bed width of about 1370 mm, queen size bed width of about 1530 mm, king size bed width of about 1830 mm and super king sized bed width of about 2030 mm.

In an embodiment of the present invention, there is provided a kit which comprises a plurality of the tile members 20 and a package (not shown) for containing a predetermined number of the tile members 20 required to form a headboard 7 for any one or more of a standard single, king single, double, queen, king sized or super king sized bed. For example, the kit may include one package for containing a predetermined number of tile members 20 required to form a headboard 7 suited for a standard single size bed, another package for containing a predetermined number of tile members 20 required to form a headboard 7 for a standard king single, a standard double size bed, another package for a standard queen size bed and another package for a standard king size bed or a standard super king sized bed.

Advantages of embodiments of the invention include that the slimline design does not attract as much dust as traditional upholstered headboards or bedheads with larger or intricate surface areas. Thus, embodiments of the present invention provide a headboard more suitable for people sensitive to dust. The size and modular nature of the headboard allows for what is traditionally a large and heavy item, to be more easily shipped in a more space efficient form, significantly reducing shipping costs and minimising the need for labour intensive delivery as is the case for traditional large and bulky headboards. Embodiments of the present invention provide items of furniture suitable for purchase online through e-commerce platforms and shipped direct to the consumer. Embodiments of the present invention provide a slimline headboard that sticks to the wall which saves on valuable room and floor space which is at a premium in modern higher density dwellings which are becoming ever smaller. Embodiments of the invention are advantageous in that they allow for packaging of predetermined numbers of tile members for use for different purposes such as for use as headboards for various bed sizes.

The present invention, and embodiments described herein, is susceptible to variation and modification without departing from the spirit or ambit of the present invention. It is understood that the invention includes all such variations, modifications and mechanical equivalents which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A wall surface covering, including:
a plurality of modular tile members comprised of a lightweight material;
each tile member comprising a decorative surface and an opposite wall surface facing surface;
means for removably adhering the tile members to a wall surface with the wall surface facing surface of each of the tile members facing the wall surface;
wherein the plurality of tile members are adapted to be located closely adjacent one another whereby the decorative surfaces of the tile members form a substantially continuous wall covering decorative surface.

2. The wall surface covering of claim 1, wherein the lightweight material has a density of between about 100 and about 900 kg/m³, or between about 100 and about 200 kg/m³ or about 160 kg/m³ and/or is comprised of balsa wood, or is between about 500 or 650 kg/m³ and/or is comprised of ply wood.

3. The wall surface covering of claim 1, wherein the means for removably adhering the tile members to the wall surface includes pressure sensitive adhesive applied to the wall facing surface of each of the tile members.

4. The wall surface covering of claim 1, wherein the decorative surfaces of the tile members include decorative elements whereby the decorative surfaces of the plurality of tile members form a tessellated pattern.

5. The wall surface covering of claim 1, wherein the dimensions of each of the plurality of tile members are the same and are of a magnitude that the overall width of n tile members is sufficient to accommodate standard single, king single, double, queen, king and super king size bed widths.

6. The wall surface covering of claim 1, wherein the dimensions of each of the plurality of tile members are about 200 mm×200 mm×4 mm

7. A headboard for a bed, including:
a plurality of modular tile members comprised of a lightweight material;
each tile member comprising a decorative surface and an opposite wall surface facing surface;
means for removably adhering the tile members to a wall surface with the wall surface facing surface of each of the tile members facing the wall surface;
wherein the plurality of tile members are adapted to be located closely adjacent one another to form a headboard for a bed wherein the decorative surfaces of the tile members form a substantially continuous wall covering surface.

8. The headboard of claim 7, wherein the lightweight material has a density of between about 100 and about 900 kg/m³, or between about 100 and about 200 kg/m³ or about 160 kg/m³ and/or is comprised of balsa wood, or is between about 500 or 650 kg/m³ and/or is comprised of ply wood.

9. The headboard of claim 7, wherein the means for removably adhering the tile members to the wall surface includes pressure sensitive adhesive applied to the wall facing surface of each of the tile members.

10. The headboard of claim 7, wherein the dimensions of each of the plurality of tile members are the same and are of a magnitude that the overall width of n tile members is sufficient to accommodate standard single, king single, double, queen, king and super king size bed widths.

11. A kit for forming a headboard, the kit including:
a plurality of tile members comprised of a lightweight material;
each tile member comprising a decorative surface and an opposite wall surface facing surface;
means for removably adhering the tile members to a wall surface with the wall surface facing surface of each of the tile members facing the wall surface;
wherein the plurality of tile members are adapted to be located closely adjacent one another whereby the tile members form a headboard comprising a substantially continuous wall covering decorative surface.

12. The kit of claim 11, further including a package for containing a predetermined number of the tile members required to form a headboard suited for any one or more of standard single, king single, double, queen, king or super king size bed widths.

13. The kit of claim 11, wherein the lightweight material has a density of between about 100 and about 900 kg/m³, or between about 100 and about 200 kg/m³ or about 160 kg/m³ and/or is comprised of balsa wood, or is between about 500 or 650 kg/m³ and/or is comprised of ply wood.

14. The kit of claim 11, wherein the means for removably adhering the tile members to the wall surface includes pressure sensitive adhesive applied to the wall facing surface of each of the tile members.

15. The kit of claim 12, wherein the dimensions of each of the plurality of tile members are the same.

16. The kit of claim 15, wherein the dimensions of the tile members are such that the overall width of n tile members is sufficient to accommodate standard single, king single, double, queen, king and super king size bed widths.
